(19) United States
(12) Patent Application Publication
(10) Pub. No.: US 2007/0137429 A1
(43) Pub. Date: Jun. 21, 2007

(54) Pedal device for cycling apparatus

(76) Inventor: Lo Pin Wang, Taichung (TW)

Correspondence Address: CHARLES E. BAXLEY, ESQ., 90 JOHN STREET, THIRD FLOOR, NEW YORK, NY, 10038, US

(21) Appl. No.: 11/253,948

(22) Filed: Oct. 18, 2005

(51) Int. Cl. G05G 1/14

(52) U.S. Cl. 74/594.6

(57) ABSTRACT

A pedal device includes a barrel for attaching to a cycling apparatus and having two or more rods resiliently supported on the barrel, and an attachment for attaching to a bicycle shoe and having two catches for selectively engaging with the rods, and for forcing the rods away from each other, to allow the catches of the attachment to move beyond the rods, and to be anchored and positioned to the rods of the pedal device. For example, the barrel includes two resilient members each having two or more orifices for engaging with the rods and to resiliently couple the rods between the resilient members and on the barrel. The barrel includes two stops for positioning the resilient members on the barrel.

### BACKGROUND OF THE INVENTION

1. Field of the Invention

The present invention relates to a pedal device, and more particularly to a pedal device for attaching to various cycling apparatuses, such as bicycles, unicycles, tricycles, cycling exercisers, etc., and for allowing bicycle shoes to be quickly attached or anchored to the pedal device, and also to be quickly and selectively detached or disengaged from the pedal device.

2. Description of the Prior Art

Typical cycling apparatuses, such as bicycles, unicycles, tricycles, cycling exercisers, etc., comprise a pair of foot pedals attached thereto, for being stepped or ridden or operated by the users. However, while riding or operating the cycling apparatuses, the bicycle shoes of the riders may easily slip relative to the foot pedals.

For preventing the bicycle shoes from slipping relative to the foot pedals, some of the bicycle shoes include one or more cleats or attachments attached to the bottom portion thereof, for engaging with or for anchoring to the pedal devices, and thus for preventing the bicycle shoes from slipping relative to the foot pedals.

For example, U.S. Pat. No. 550,409 to Hanson discloses one of the typical attachments for bicycle pedals also comprising one or more cleats or attachments attached to the bottom portion of the bicycle shoes, for engaging with or for anchoring to the pedal devices of typical cycling apparatuses, by rotating the cleats or attachments of the bicycle shoes relative to the pedal devices for a predetermined angle.

However, the typical pedal devices comprise a predetermined or integral structure that the cleats or attachments of the bicycle shoes may not be easily engaged therewith. For example, when engaging the cleats or attachments of the bicycle shoes with the typical pedal devices, both of the feet of the user have to be precisely rotated relative to the pedal devices for the predetermined angle, to align the cleats or attachments with the pedal devices, and to allow the cleats or attachments to be engaged with the bicycle pedal devices.

The present invention has arisen to mitigate and/or obviate the afore-described disadvantages of the conventional pedal devices for cycling apparatuses.

### SUMMARY OF THE INVENTION

The primary objective of the present invention is to provide a pedal device for attaching to various cycling apparatuses, and for allowing bicycle shoes to be quickly attached or anchored to the pedal device, and also to be quickly and selectively detached or disengaged from the pedal device.

In accordance with one aspect of the invention, there is provided a pedal device for attaching to a cycling apparatus, the pedal device comprising a barrel for attaching to the cycling apparatus, a first rod and at least one second rod resiliently supported on the barrel, and an attachment for attaching to a bicycle shoe, and including two catches for selectively engaging with the first and the second rods, and for selectively forcing the first and the second rods away from each other, to allow the catches of the attachment to move beyond the first and the second rods, and to be anchored and positioned to the first and the second rods of the pedal device.

The barrel includes two resilient members disposed thereon and each having at least two orifices formed therein for engaging with and for receiving the first and the second rods therein, to allow the first and the second rods to be resiliently coupled between the resilient members and to be resiliently supported on the barrel.

The barrel includes two stops disposed thereon, for engaging with the resilient members respectively and for positioning the resilient members on the barrel. The stops each includes a depression formed therein, for receiving the resilient members respectively. The barrel includes a first of the stops extended therefrom, and a second of the stops attached thereto.

The barrel includes a segment provided on one end thereof and having a non-circular cross section, the second stop includes a tubular member having a non-circular opening formed therein for engaging with the non-circular segment of the barrel, and for anchoring and positioning the second stop to the barrel, and for preventing the second stop from being rotated relative to the barrel.

The second stop includes a projection extended into the opening thereof, for engaging with the segment of the barrel, and for anchoring and positioning the second stop to the barrel, and for preventing the second stop from being moved relative to the barrel.

A shaft may further be provided and includes a first end for attaching to the cycling apparatus, and the barrel including a bore formed therein for receiving and engaging onto the shaft. The shaft includes a tapered segment provided thereon and located between two cylindrical segments, and two gaskets engaged onto the cylindrical segments of the shaft respectively, for supporting the barrel on the shaft.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a bicycle having a pedal device in accordance with the present invention;

FIG. 2 is a perspective view similar to FIG. 1, illustrating a cycling exerciser having a pedal device in accordance with the present invention;

FIG. 3 is an exploded view illustrating one of the pedal devices;

FIG. 4 is a perspective view illustrating the pedal device as shown in FIG. 3;

FIG. 5 is a partial exploded view illustrating the operation of the pedal device;

FIG. 6 is an upper plan view of the pedal device;

FIG. 7 is an upper plan view similar to FIG. 6, illustrating the operation of the pedal device;

FIG. 8 is a cross sectional view of the pedal device, taken along lines 8-8 of FIG. 4;

FIG. 9 is a cross sectional view of the pedal device, taken along lines 9-9 of FIG. 5; and

FIGS. 10 and 11 are cross sectional views similar to FIG. 9, illustrating the operation of the pedal device.

### DETAILED DESCRIPTION OF THE PREFERRED EMBODIMENT

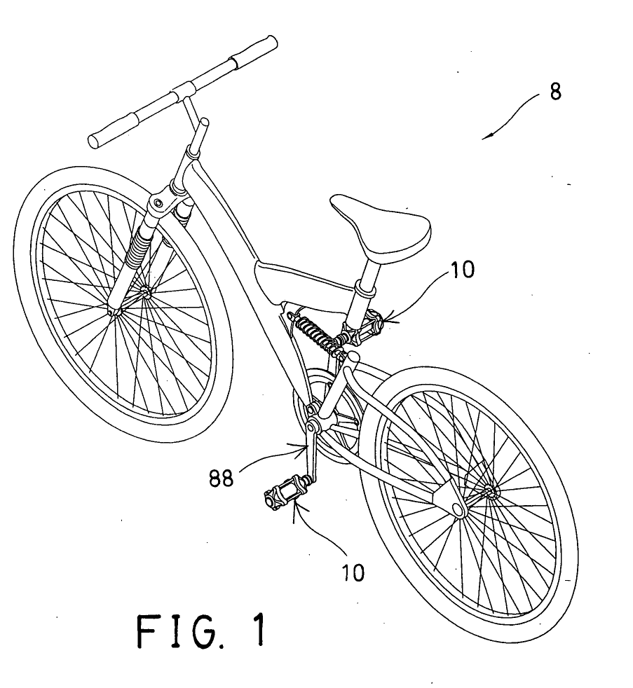

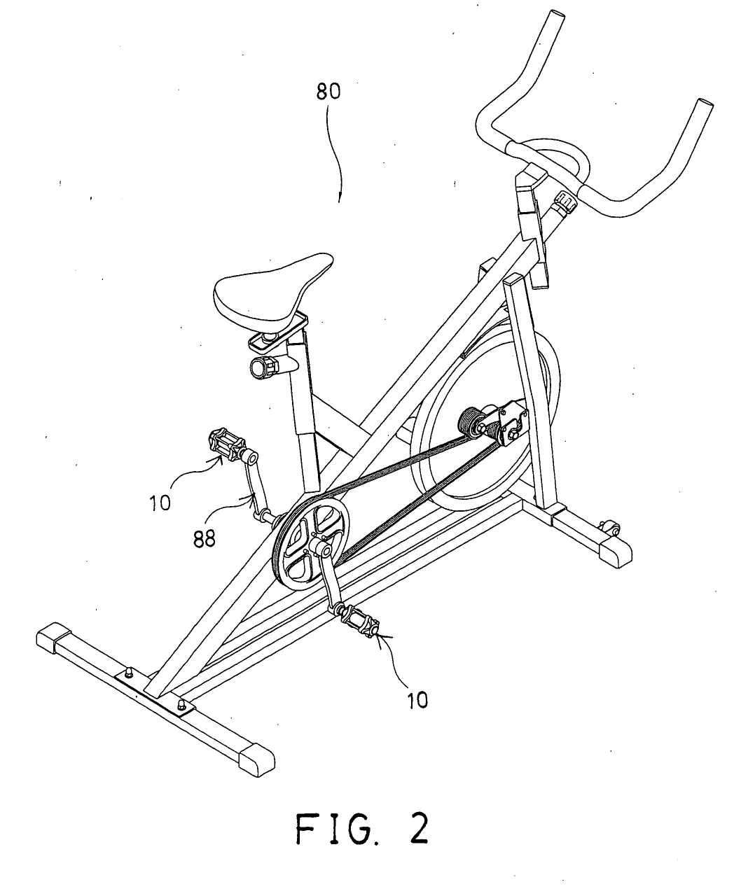

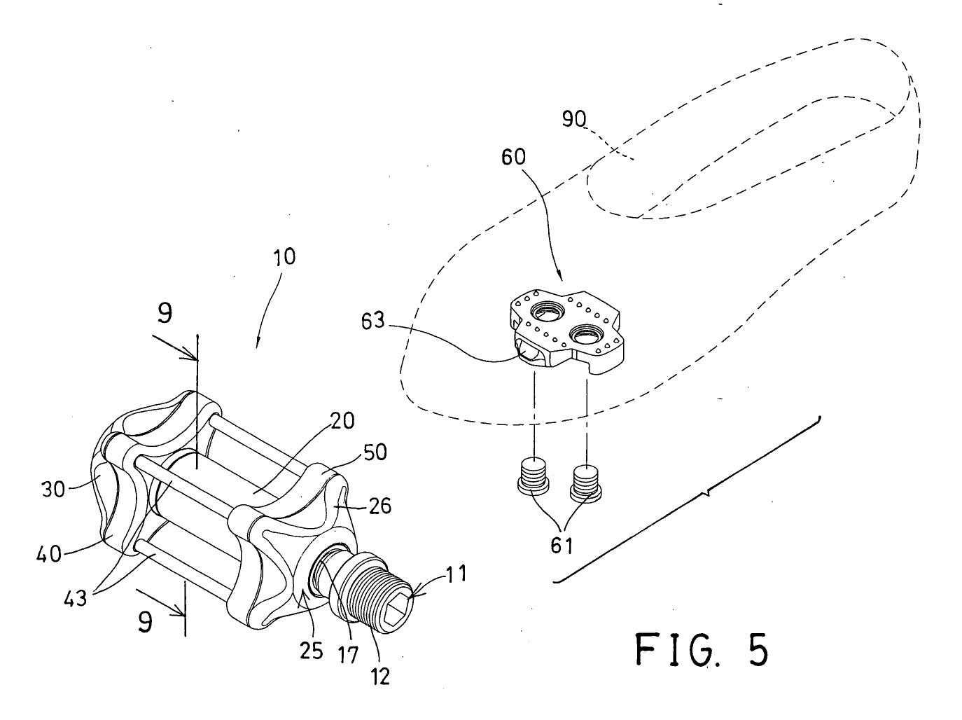

Referring to the drawings, and initially to FIGS. 1 and 2, a pedal device 10 in accordance with the present invention is provided or arranged for attaching to the crank device 88 of various cycling apparatuses 8, such as bicycles 8 (FIG. 1), unicycles or tricycles (not shown), cycling exercisers 80 (FIG. 2), etc., and for allowing a bicycle shoe 90 (FIG. 5) to be quickly attached or anchored to the pedal device 10, and also to be quickly and selectively detached or disengaged from the pedal device 10.

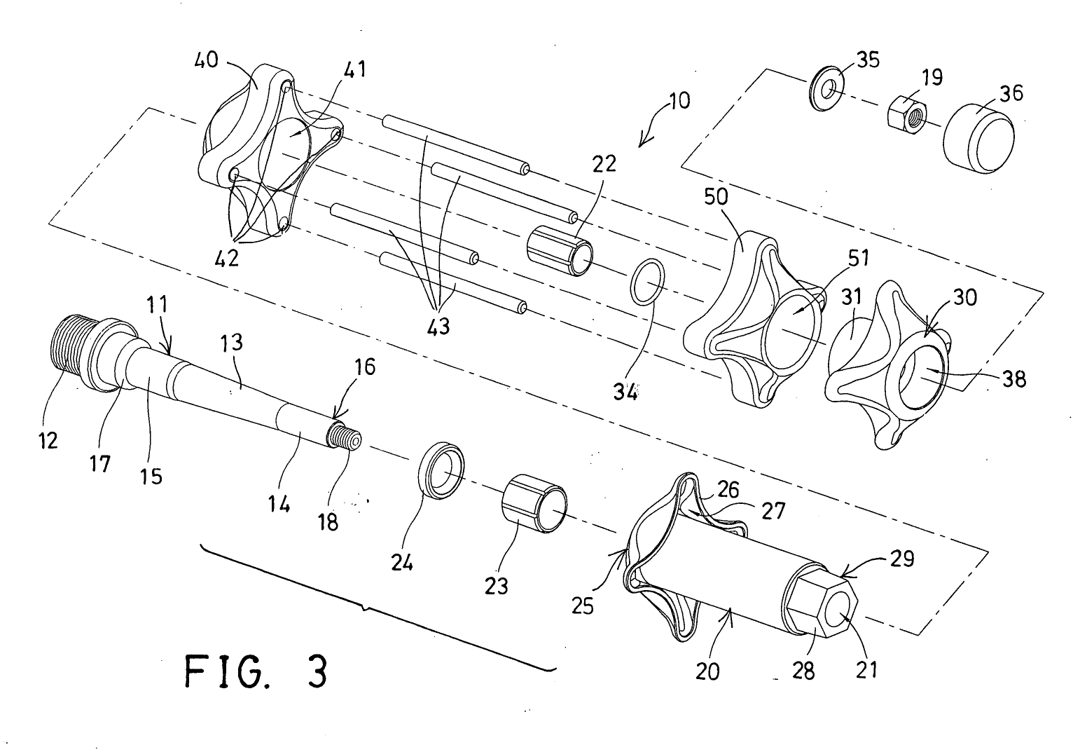

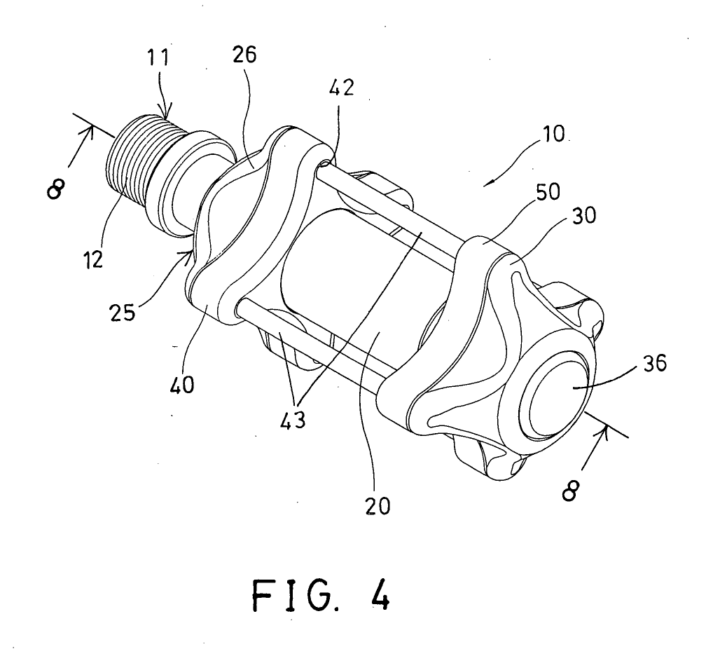

As shown in FIGS. 3-9, the pedal device 10 comprises a shaft 11 including one end 12, such as a threaded end or an inner end 12 for threading or attaching or securing to the crank device 88 of the cycling apparatus 8, and including an inclined or tapered or con-shaped segment 13 formed or provided in the middle portion thereof, and preferably located between two cylindrical segments 14, 15, in which one of the cylindrical segments 14 is located close to the other or outer end 16 of the shaft 11, and the other cylindrical segment 15 is located closer to the inner end or the threaded end 12 of the shaft 11.

It is preferable that the cylindrical segment 15 includes an outer diameter slightly smaller than that of the inner or threaded end 12 of the shaft 11, to form or define a peripheral shoulder 17 therebetween, and the outer diameter of the cylindrical segment 15 is greater than that of the outer cylindrical segment 14. The shaft 11 further includes an outer thread 18 formed or provided in the other end 16 thereof, for threading or engaging with a lock nut 19, for example.

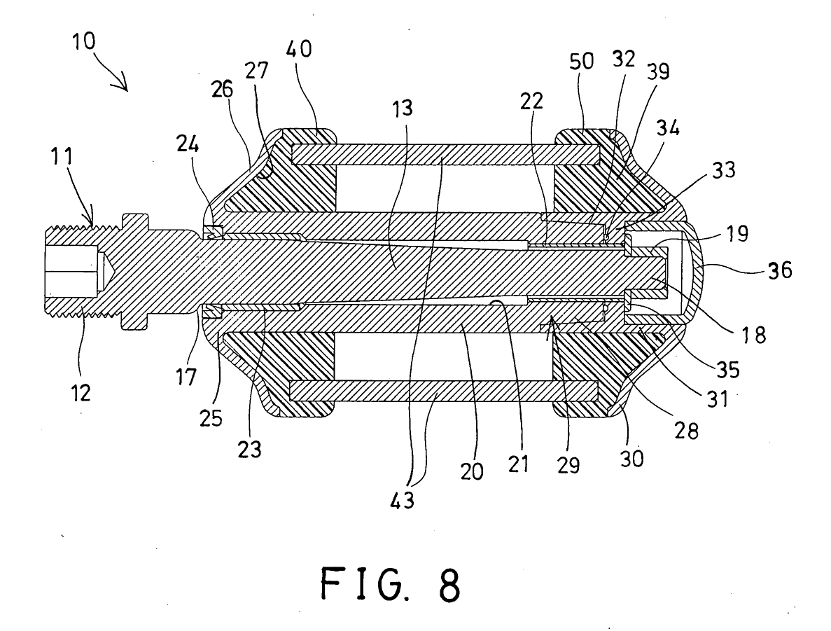

A barrel 20 includes a bore 21 formed therein for rotatably receiving or engaging onto the shaft 11, with one or more, such as two gaskets 22, 23 which are preferably engaged onto the cylindrical segments 14, 15 of the shaft 11 respectively, best shown in FIGS. 8-10. Another gasket or sealing ring 24 may further be provided and engaged into one end or inner end 25 of the barrel 20, and engaged with the peripheral shoulder 17 of the shaft 11 (FIG. 8), for limiting the barrel 20 to rotate relative to the shaft 11 only, and for preventing the barrel 20 from sliding longitudinally relative to or along the shaft 11.

The barrel 20 includes an enlarged partition or wall or stop 26 formed or provided or extended on the inner end 25 thereof, and having a depression 27 formed therein, and includes a reduced segment 28 formed or provided in the other or outer end portion 29 thereof, and preferably having a non-circular cross section, such as a hexagonal cross section as shown in FIG. 3. The reduced segment 28 may include an outer diameter smaller or greater than or equal to that of the barrel.

Another enlarged partition or wall or stop 30 may further be provided and attached onto the other or outer end portion 29 of the barrel 20, for example, the stop 30 includes a tubular member 31 having a non-circular opening 32 formed in the inner portion thereof (FIG. 8), for engaging with the non-circular segment 28 of the barrel 20, and thus for anchoring and positioning the stop 30 to the other or outer end portion 29 of the barrel 20, and for preventing the stop 30 from being rotated relative to the barrel 20.

The stop 30 further includes a projection 33, such as a peripheral projection 33 extended into the opening 32 thereof, for engaging with the segment 28 of the barrel 20 (FIG. 8), and for anchoring and positioning the stop 30 to the barrel 20, and thus to stably attach the stop 30 to the barrel 20, and to prevent the stop 30 from being moved relative to the barrel 20. A sealing ring 34 may further be provided and engaged between the projection 33 of the stop 30 and the segment 28 of the barrel 20, for making an air tight or a water tight seal therebetween.

It is preferable that a washer 35 is further provided and engaged onto the threaded end 16 of the shaft 11, and engaged between the lock nut 19 and the projection 33 of the stop 30, for solidly attaching or securing the stop 30 to the shaft 11. A cap 36 may be engaged into the outer portion of the stop 30, such as engaged into an outer cavity 38 of the stop 30 (FIG. 3), for enclosing and shielding the lock nut 19 and the threaded end 16 of the shaft 11. The stop 30 also includes a depression 39 formed therein (FIG. 8).

Two soft or spring or resilient members 40, 50 may be made of plastic or rubber or other synthetic materials, and each includes a bore 41, 51 formed therein for engaging onto the barrel 20, and the resilient members 40, 50 may be engaged with the stops 26, 30 respectively, such as stably seated or received within the depressions 27, 39 of the stops 26, 30 respectively, to allow the resilient members 40, 50 to be stably positioned or attached on the shaft 11. The resilient members 40, 50 each includes two or more orifices 42 formed therein for engaging with or for receiving two or more rods 43 therein, to allow the rods 43 to be spring or resiliently coupled between the resilient members 40, 50, or to be resiliently supported on the barrel 20.

As shown in FIGS. 5-7 and 9-11, an attachment 60 may be attached or secured to the bicycle shoe 90 with one or more fasteners 61, or the like, and includes two end or side catches 63 for selectively engaging with the rods 43 and for selectively anchoring or positioning the bicycle shoe 90 to the pedal device 10. The spring or resilient coupling of the rods 43 between the resilient members 40, 50 allows the end or side catches 63 of the attachment 60 to force or to move two of the rods 43 away from each other (FIG. 10), and to allow the attachment 60 to be easily and quickly anchored or secured to or retained by the rods 43 of the pedal device 10.

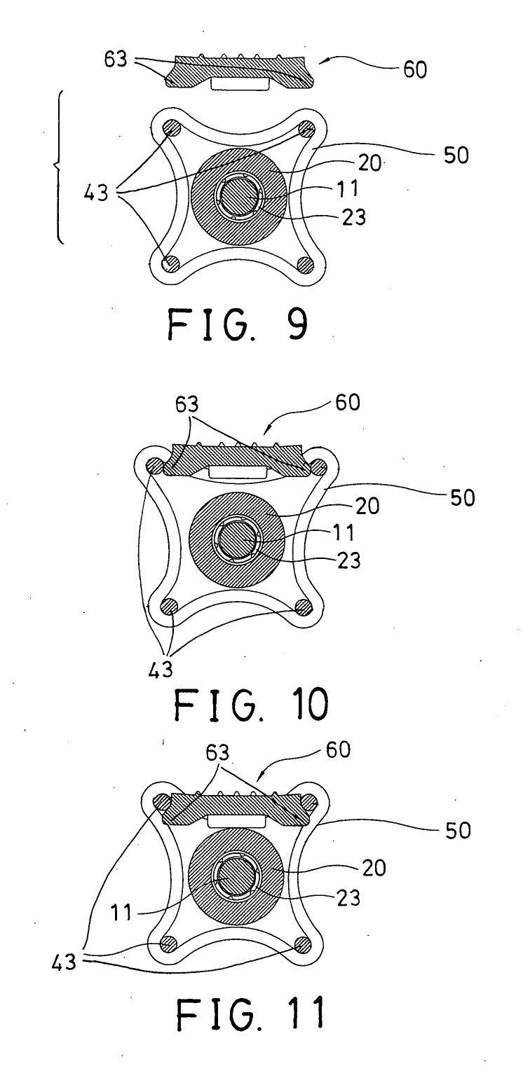

In operation, as shown in FIGS. 9-11, when the bicycle shoe 90 is stepped onto the pedal device 10, to force the catches 63 of the attachment 60 to engage with two of the rods 43, the rods 43 may be forced to move away from each other (FIG. 10) by the attachment 60, and to allow the attachment 60 to be easily and quickly engaged or moved beyond the rods 43, and to be anchored or secured to or retained by the rods 43 of the pedal device 10 (FIG. 11), and thus to allow the attachment 60 and the bicycle shoe 90 to be easily anchored to the rods 43 or the barrel 20 of the pedal device 10 without rotating the attachment 60 and the bicycle shoe 90 relative to the pedal device 10.

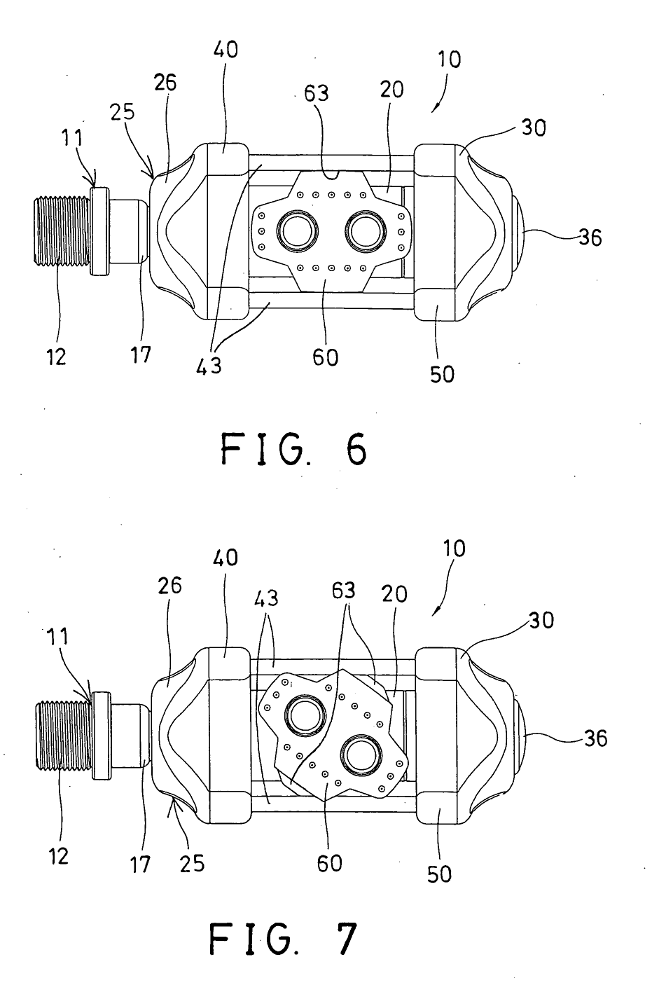

As shown in FIGS. 6 and 7, when it is required to detach or to disengage the attachment 60 and the bicycle shoe 90 from the barrel 20 of the pedal device 10, it is only required to rotate the attachment 60 and the bicycle shoe 90 relative to the pedal device 10 for a selected angle (FIG. 7), to allow the catches 63 of the attachment 60 to be disengaged or offset from the rods 43, and-thus to allow the attachment 60 and the bicycle shoe 90 to be easily and quickly disengaged from the rods 43 of the pedal device 10.

The conventional or typical attachments for bicycle pedals failed to disclose or to teach two or more rods 43 resiliently attached to a barrel 20, and arranged to allow the rods 43 to be forced and moved away from each other by the attachment 60, and to allow the attachment 60 and the bicycle shoe 90 to be easily anchored to the rods 43 or the barrel 20 of the pedal device 10 without rotating the attachment 60 and the bicycle shoe 90 relative to the pedal device 10.

Accordingly, the pedal device in accordance with the present invention may be attached to various cycling apparatuses, for allowing bicycle shoes to be quickly attached or anchored to the pedal device, and also to be quickly and selectively detached or disengaged from the pedal device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pedal device for attaching to a cycling apparatus, said pedal device comprising:
a barrel for attaching to the cycling apparatus,
a first rod and at least one second rod resiliently supported on said barrel, and
an attachment for attaching to a bicycle shoe, and including two, catches for selectively engaging with said first and said at least one second rods, and for selectively forcing said first and said at least one second rods away from each other, to allow said catches of said attachment to move beyond said first and said at least one second rods, and to be anchored and positioned to said first and said at least one second rods of said pedal device.

2. The pedal device as claimed in claim 1, wherein said barrel includes two resilient members disposed thereon and each having at least two orifices formed therein for engaging with and for receiving said first and said at least one second rods therein, to allow said first and said at least one second rods to be resiliently coupled between said resilient members and to be resiliently supported on said barrel.

3. The pedal device as claimed in claim 2, wherein said barrel includes two stops disposed thereon, for engaging with said resilient members respectively and for positioning said resilient members on said barrel.

4. The pedal device as claimed in claim 3, wherein said stops each includes a depression formed therein, for receiving said resilient members respectively.

5. The pedal device as claimed in claim 3, wherein said barrel includes a first of said stops extended therefrom, and a second of said stops attached thereto.

6. The pedal device as claimed in claim 5, wherein said barrel includes a segment provided on one end thereof and having a non-circular cross section, said second stop includes a tubular member having a non-circular opening formed therein for engaging with said non-circular segment of said barrel, and for anchoring and positioning said second stop to said barrel, and for preventing said second stop from being rotated relative to said barrel.

7. The pedal device as claimed in claim 6, wherein said second stop includes a projection extended into said opening thereof, for engaging with said segment of said barrel, and for anchoring and positioning said second stop to said barrel, and for preventing said second stop from being moved relative to said barrel.

8. The pedal device as claimed in claim 1 further comprising a shaft including a first end for attaching to the cycling apparatus, and said barrel including a bore formed therein for receiving and engaging onto said shaft.

9. The pedal device as claimed in claim 8, wherein said shaft includes a tapered segment provided thereon and located between two cylindrical segments, and two gaskets engaged onto said cylindrical segments of said shaft respectively, for supporting said barrel on said shaft.
